(19) United States
(12) Patent Application Publication
(10) Pub. No.: US 2026/0327099 A1
(43) Pub. Date: Oct. 22, 2026

(54) PER- AND POLYFLUOROALKYL SUBSTANCES (PFAS) CAPTURING FILTER, AND PFAS CAPTURING APPARATUS INCLUDING SAME

(71) Applicant: SAMSUNG ELECTRONICS CO., LTD., Suwon-si (KR)

(72) Inventors: Jimin BAEK, Suwon-si (KR); Sukeun EOM, Suwon-si (KR); Seonhoo KIM, Suwon-si (KR); Samjong CHOI, Suwon-si (KR)

(73) Assignee: SAMSUNG ELECTRONICS CO., LTD., Suwon-si (KR)

(21) Appl. No.: 19/529,484

(22) Filed: Feb. 4, 2026

(30) Foreign Application Priority Data
Feb. 13, 2025 (KR) 10-2025-0018794
Apr. 14, 2025 (KR) 10-2025-0048394

(51) Int. Cl. C02F 1/44; B01D 15/18; B01D 15/20; B01D 63/06; C02F 1/28; C02F 101/36

(52) U.S. Cl. CPC C02F 1/44; B01D 15/1896; B01D 15/20; B01D 63/06; C02F 1/28; B01D 2313/22; B01D 2313/367; C02F 2101/36; C02F 2201/009

(57) ABSTRACT

A per- and polyfluoroalkyl substances (PFAS) capturing filter including a first body extending in a vertical direction; a first cage surrounding a side surface of the first body, a membrane filter surrounding the first cage and configured to adsorb PFAS, a second cage horizontally spaced apart from the membrane filter by a predetermined distance, surrounding the membrane filter in a lateral direction, and including a protrusion bent at a lower side, a thermoelectric element surrounding the second cage and configured to control the temperature of the membrane filter.

### CROSS-REFERENCE TO RELATED APPLICATION

This application is based on and claims priority under 35 U.S.C. § 119 to Korean Patent Application No. 10-2025-0018794, filed on Feb. 13, 2025, and Korean Patent Application No. 10-2025-0048394, filed on Apr. 14, 2025, in the Korean Intellectual Property Office, the disclosures of which are incorporated by reference herein in their entirety.

### BACKGROUND

The inventive concept relates to a per- and polyfluoroalkyl substances (PFAS) capturing filter and a PFAS capturing apparatus including the same, and more particularly, to a PFAS capturing filter for detecting PFAS contained at a low concentration in fluid, and a PFAS capturing apparatus including the PFAS capturing filter.

Recently, as environmental pollution issues and food safety issues have come to the fore, interest in PFAS has increased. PFAS is widely used in various industrial fields such as clothing, furniture, home appliances, and food packaging due to its durability and excellent waterproof properties.

However, PFAS is known to be a substance that may have a harmful effect on the human body. PFAS may accumulate in the body and cause diseases such as cancer, diabetes, and obesity, and there is a risk of causing environmental pollution and adversely affecting the ecosystem. Due to these issues, five EU countries are strengthening regulations on all PFAS substances, and regulations on PFAS are gradually being strengthened worldwide. In particular, because materials used in semiconductor processes may also come into contact with the human body, PFAS regulations are expected to become more stringent in the future.

In order to assess the risk of PFAS substances and take appropriate measures, technology to accurately analyze PFAS substances is essential. However, PFAS substances are very fine and have a complex structure, making them difficult to analyze. Existing PFAS analysis methods have the problem that the process of extracting and analyzing PFAS substances is complicated and time-consuming, and it is difficult to accurately measure the concentration of PFAS substances.

Therefore, it is necessary to develop a technology that may efficiently detect and quantify PFAS substances.

### SUMMARY

The inventive concept provides a per- and polyfluoroalkyl substances (PFAS) capturing filter capable of detecting and analyzing PFAS from a fluid containing a low concentration of PFAS, and a PFAS capturing apparatus including the PFAS capturing filter.

In addition, the problems to be solved by the technical spirit of the present inventive concept are not limited to the problems mentioned above, and other problems not mentioned will be clearly understood by those skilled in the art from the following description.

In order to achieve the technical problem, the inventive concept provides the following PFAS capturing filter.

According to an aspect of the inventive concept, there is provided a PFAS capturing filter including a first body extending in a vertical direction, a first cage surrounding a side of the first body, a membrane filter surrounding the first cage and configured to adsorb PFAS, a second cage horizontally spaced apart from the membrane filter by a predetermined distance, surrounding the membrane filter in a lateral direction, and including a protrusion bent on a lower side, and a thermoelectric element surrounding the second cage and configured to control a temperature of the membrane filter.

According to another aspect of the inventive concept, there is provided a PFAS capturing apparatus including an upper case in which an inlet is positioned, a lower case positioned at a lower side of the upper case and having an outlet positioned on a lower surface of the lower case, a coupling member configured to couple and separate the upper case and the lower case, and a PFAS capturing filter positioned within the lower case, wherein the PFAS capturing filter includes a first body extending in a vertical direction, a first cage surrounding a side surface of the first body, a membrane filter surrounding the first cage and configured to adsorb PFAS, a second cage horizontally spaced apart from the membrane filter by a predetermined distance, surrounding the membrane filter in a lateral direction, and including a protrusion bent at a lower side, and a thermoelectric element surrounding the second cage and configured to control a temperature of the membrane filter.

According to another aspect of the inventive concept, there is provided a PFAS capturing apparatus including an upper case having an inlet positioned on an upper surface thereof, a lower case positioned at a lower portion of the upper case and having an outlet positioned at a lower surface of the lower case, a coupling member configured to couple and separate the upper case and the lower case, a handle coupled to the upper case, and a PFAS capturing filter positioned within the lower case, wherein the PFAS capturing filter includes a first body extending in a vertical direction, a first cage surrounding a side surface of the first body, a membrane filter surrounding the first cage and configured to adsorb PFAS, a second cage horizontally spaced apart from the membrane filter by a predetermined distance, surrounding the membrane filter in a lateral direction, and including a protrusion bent on a lower side, and a thermoelectric element surrounding the second cage and configured to control the temperature of the membrane filter, wherein the membrane filter includes a surface to which a self-assembled monolayer (SAM) for selective adsorption of PFAS substances is applied, and a specific recognition site formed using molecularly imprinted polymer (MIP) technology, the first cage, the membrane filter, the second cage, and the thermoelectric element are each coupled to and separated from each other, and the thermoelectric element is flexible to be bent at a constant curvature corresponding to the structure of the second cage.

In order to achieve the technical problem, the inventive concept provides a method of capturing PFAS as described below.

According to an aspect of the inventive concept, there is provided a method of capturing PFAS, the method includes injecting a fluid containing PFAS into a PFAS capturing apparatus, filtering the fluid including PFAS through a PFAS capturing filter including a thermoelectric device and membrane filter, determining whether the number of filtrations satisfies a target value, re-injecting the filtered fluid into the PFAS capturing apparatus if the number of filtrations does not satisfy the target value, separating the PFAS capturing filter from the PFAS capturing apparatus if the number of filtrations satisfies the target value.

In some embodiments, the thermoelectric element may raise the membrane filter to a first temperature before the fluid including the PFAS is introduced into the PFAS capturing apparatus.

In some embodiments, the first temperature may be in a range of about 90 °C to about 110 °C.

In some embodiments, the thermoelectric element may be powered by solar energy.

In some embodiments, the PFAS capturing apparatus may include an upper case, a lower case, and a coupling member, and the lower case may include a transparent material.

In some embodiments, the PFAS capturing apparatus may further include a handle.

In some embodiments, the fluid passing through the PFAS capturing filter may be discharged through an outlet formed on the lower case, and the fluid passing through the PFAS capturing filter may be stored in a lower support that is coupled with and separated from the lower case and has a recess.

In some embodiments, the PFAS capturing filter may further include a first body, a first cage, and a second cage, and the thermoelectric element may be flexible so as to be able to bend at a predetermined curvature corresponding to the structure of the second cage.

In some embodiments, the membrane filter may include a surface to which SAM for selective adsorption of PFAS substances is applied, and a specific recognition site formed using a MIP technology.

In some embodiments, the PFAS capturing apparatus may further include an upper case, a lower case, and a coupling member, and a magnetic material may be positioned on a surface of each of the upper case and the lower case that contacts the coupling member, and the coupling member may have magnetic properties.

### BRIEF DESCRIPTION OF THE DRAWINGS

Embodiments will be more clearly understood from the following detailed description taken in conjunction with the accompanying drawings in which:

FIG. 1 is a flowchart showing a method of capturing per- and polyfluoroalkyl substances (PFAS), according to an embodiment;

FIG. 2 is a schematic diagram showing a PFAS capturing apparatus according to an embodiment;

FIG. 3 is a cross-sectional view taken along line A1-A1″ of FIG. 2, according to an embodiment;

FIG. 4 is a schematic diagram for explaining a PFAS capturing filter of FIG. 2;

FIG. 5 is a schematic diagram showing a thermoelectric element of FIG. 3;

FIG. 6 is a schematic diagram for explaining coupling and separation of an upper case and a lower case of FIG. 2;

FIG. 7 is a cross-sectional view showing a PFAS capturing apparatus according to an embodiment; and

FIG. 8 is a cross-sectional view showing a PFAS capturing filter according to an embodiment.

### DETAILED DESCRIPTION OF THE EMBODIMENTS

Hereinafter, embodiments of the present inventive concept will be described in detail with reference to the accompanied drawings. Like reference numerals are used for like elements in the drawings, and the descriptions thereof are omitted.

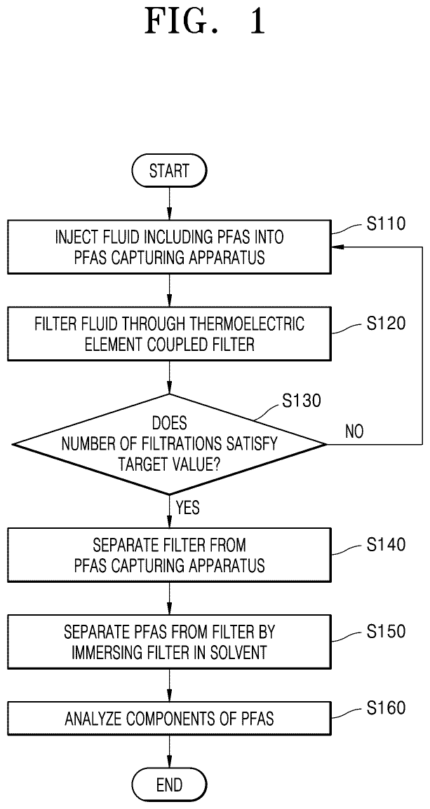

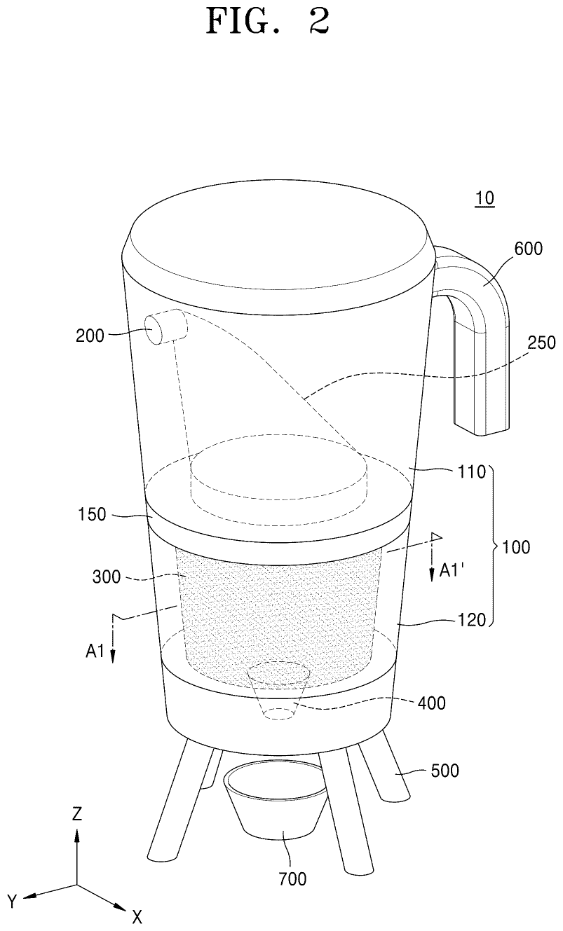

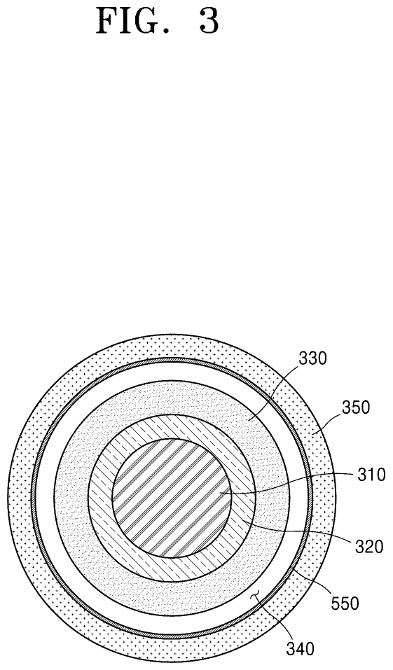

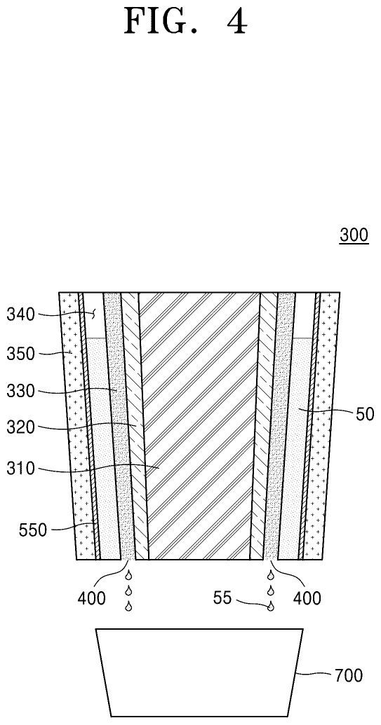

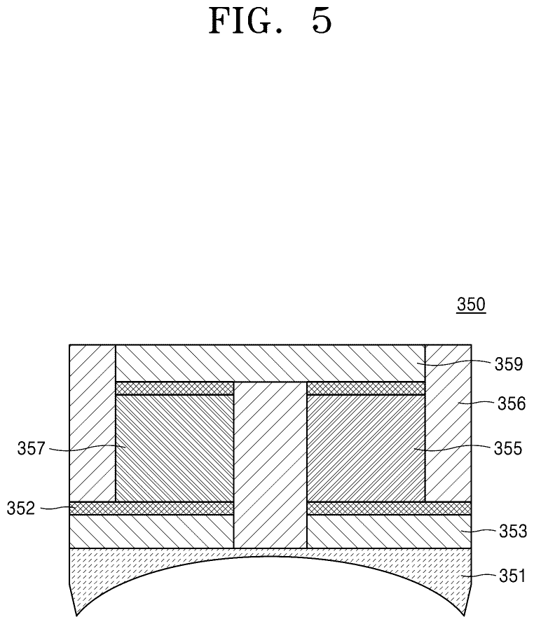

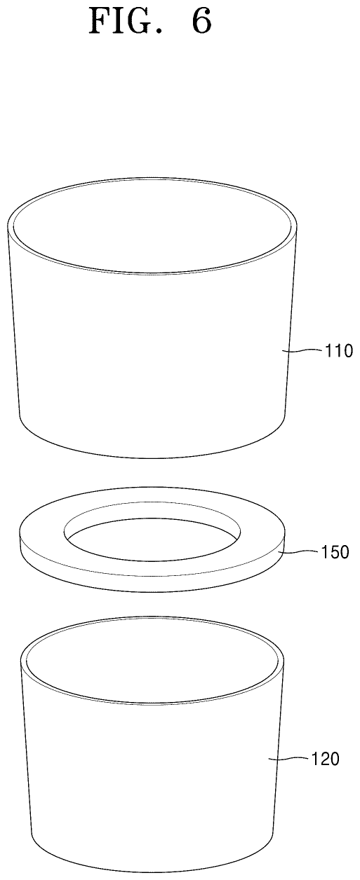

FIG. 1 is a flowchart showing a method of capturing per- and polyfluoroalkyl substances (PFAS), according to an embodiment. FIG. 2 is a schematic diagram showing a PFAS capturing apparatus 10 according to an embodiment. FIG. 3 is a cross-sectional view taken along line A1-A1′ of FIG. 2. FIG. 4 is a schematic diagram for explaining a PFAS capturing filter 300 of FIG. 2. FIG. 5 is a schematic diagram showing a thermoelectric element of FIG. 3. FIG. 6 is a schematic diagram for explaining coupling and separation of an upper case and a lower case of FIG. 2.

Referring to FIGS. 1 to 6, the method (S100) of capturing PFAS, according to an embodiment may include an operation of injecting a fluid containing PFAS into a PFAS capturing apparatus 10 (S110), an operation of filtering the fluid through a filter coupled with a thermoelectric device (S120), an operation of determining whether the number of filtrations satisfies a target value (S130), an operation of re-injecting the filtered fluid into the PFAS capturing apparatus 10 if the number of filtrations does not satisfy the target value (S110), and an operation of separating the filter from the PFAS capturing apparatus 10 if the number of filtrations satisfies the target value (S140), and an operation of separating PFAS from the filter by immersing the filter in a solvent (S150).

First, the operation (S110) of injecting a fluid 50 including PFAS into the PFAS capturing apparatus 10 may be performed by providing the fluid 50 including PFAS to a PFAS capturing apparatus 10 including a PFAS capturing filter 300. According to some embodiments, in the fluid 50 including PFAS, the concentration of PFAS may be a concentration that may not be detected by an electrochemical sensor, an optical sensor, or a fluorescent sensor. For example, the concentration of PFAS may be 1 ug/L or less. Here, the electrochemical sensor detects PFAS by applying a voltage to the fluid 50 including PFAS and measuring a change in current, and may be a sensor that detects PFAS mainly by utilizing an oxidation-reduction reaction that occurs on an electrode surface. In addition, the optical sensor detects PFAS by measuring a change in absorption, reflection, scattering, or refraction of light, and may be a sensor that detects PFAS by detecting a change in the characteristics of light using a material that interacts with PFAS, such as a dye or nanomaterial. The fluorescent sensor may detect PFAS by utilizing the luminescence characteristics of a fluorescent substance, and detect PFAS by detecting a change in the intensity or wavelength of fluorescence when PFAS binds or interacts with a fluorescent substance.

The PFAS capturing apparatus 10 into which the fluid 50 including PFAS is injected may include a case 100, a coupling member 150, an inlet 200, a guide unit 250, a PFAS capturing filter 300, and an outlet 400.

According to some embodiments, the case 100 may be composed of an upper case 110 and a lower case 120. The upper case 110 and the lower case 120 may be coupled with or separated from each other by the coupling member 150, as illustrated in FIG. 6. For example, each of the upper case 110 and the lower case 120 may be coupled with or separated from the coupling member 150. According to some embodiments, the coupling member 150 may have a circular ring shape.

In some embodiments, the coupling member 150 may be coupled with and separated from the upper case 110 and the lower case 120 in a snap ring manner. The snap ring manner may be a manner in which the coupling member 150 having a circular ring-shape is fitted into a groove included in each of the upper case 110 and the lower case 120. According to some embodiments, the coupling member 150 may be coupled with and separate from the upper case 110 and the lower case 120 through a screw coupling ring manner. The screw coupling ring manner may be a manner in which the upper case 110 and the lower case 120 are coupled or separated through a thread located on the coupling member 150. At this time, the coupling member 150 may be coupled or separated from each of the upper case 110 and the lower case 120 through rotation. In some embodiments, the coupling member 150 may be coupled with and separated from the upper case 110 and the lower case 120 through a clamp ring method. The clamp ring method may be a method of coupling and separating the upper case 110 and the lower case 120 by tightening the coupling member 150. In some embodiments, the coupling member 150 may be coupled with and separated from the upper case 110 and the lower case 120 through a magnetic ring method. The magnetic ring method may be a method in which each of the upper case 110 and the lower case 120 is coupled with or separated from the coupling member 150 by magnetic force. At this time, the coupling member 150 may include a magnetic material, and the magnetic material may be positioned on a surface of each of the upper case 110 and the lower case 120 that comes into contact the coupling member 150.

The upper case 110 may include the inlet 200 and a guide unit 250. The inlet 200 may provide a passage through which the fluid 50 including PFAS flows into the upper case 110. In some embodiments, the inlet 200 may be located on a side of the upper case 110. However, the location of the inlet 200 is not limited thereto, and in some embodiments, the inlet 200 may be located on an upper surface of the upper case 110.

The fluid 50 including PFAS flowing in through the inlet 200 may move along the guide unit 250. The guide unit 250 may be configured to provide a passage through which the fluid 50 including PFAS flowing in through the inlet 200 moves to the PFAS capturing filter 300.

The PFAS capturing filter 300 may be located within the lower case 120. The fluid 50 including PFAS provided to the PFAS capturing apparatus 10 may be provided to the PFAS capturing filter 300 along the inlet 200 and the guide unit 250.

An operation (S120) of filtering the fluid 50 through a filter coupled with a thermoelectric element may be performed by the PFAS capturing filter 300. The fluid 50 including PFAS provided to the PFAS capturing filter 300 may be filtered through the PFAS capturing filter 300. The PFAS capturing filter 300 may include a first body 310, a first cage 320, a membrane filter 330, a second cage 550, and a thermoelectric element 350.

The first body 310 may be located at the center of the PFAS capturing filter 300. According to some embodiments, the first body 310 may have a shape extending in a vertical direction (Z). In some embodiments, the first body 310 may have a cylindrical shape. However, the shape of the first body 310 is not limited thereto. The first body 310 may have a shape to which the first cage 320 can be attached.

The first cage 320 may surround a side of the first body 310. The first cage 320 may be attached to the first body 310. The first cage 320 may be configured to be coupled with or separated from the first body 310. The first cage 320 may be configured to bend at a constant curvature. Accordingly, the first cage 320 may be coupled or separated while wrapping around the side of the first body 310.

According to some embodiments, the first cage 320 may include a substrate. The substrate includes a polar substrate, which may allow PFAS in the fluid 50 including PFAS to be more easily captured by the membrane filter 330.

The membrane filter 330 may be coupled with or separated from the first cage 320. The membrane filter 330 may be attached to the side of the first cage 320. The membrane filter 330 may be configured to bend at a certain curvature. Accordingly, the membrane filter 330 may be coupled with or separated from the side of the first cage 320 while wrapping around the side of the first cage 320.

According to some embodiments, the membrane filter 330 may be configured of a component capable of effectively adsorbing PFAS materials. According to some embodiments, the membrane filter 330 may include a porous and nano-structured material. In addition, the material forming the membrane filter 330 may be polarized. Through this, the membrane filter 330 may selectively adsorb PFAS.

According to some embodiments, the membrane filter 330 may be applied with self-assembled monolayer (SAM) technology and molecularly imprinted polymer (MIP) technology. SAM may be formed as a single layer on a surface of the membrane filter 330 using a specific anchor group. Through this, the surface properties of the membrane filter 330 may be controlled and the interaction with the PFAS substance may be optimized. The membrane filter 330 may have a surface that is friendly and selectively adsorbed to the PFAS substance through SAM technology.

The MIP technology may be additionally applied to the membrane filter 330. The MIP technology may be understood as a technology that forms a specific recognition site based on a molecular structure of the target substance, PFAS, so that the PFAS substance may be selectively adsorbed. Specifically, by providing an artificially formed recognition site using a PFAS material as a template on a surface or inside of the membrane filter 330, the membrane filter 330 may have a high selectivity with respect to the PFAS material.

As a result, the membrane filter 330 according to the technical idea of the inventive concept may significantly improve the ability to selectively adsorb and capture PFAS materials by combining SAM technology and MIP technology with the membrane filter 330. By controlling the surface properties with SAM technology and securing a high selectivity for the target material with MIP technology, various PFAS materials may be precisely detected and captured.

The second cage 550 may be provided at a predetermined distance from the membrane filter 330 in a horizontal direction. The second cage 550 may be configured to be bent at a constant curvature. In addition, the second cage 550 may include a bent protrusion at a lower side thereof. The protrusion may contact the membrane filter 330. Because the second cage 550 is spaced apart from the membrane filter 330 by a predetermined distance and includes the bent protrusion bent at the lower side thereof, the fluid 50 including PFAS may remain in a space 340 between the second cage 550 and the membrane filter 330. That is, the fluid 50 including PFAS that has moved along the inlet 200 and the guide unit 250 is introduced into the space 340 between the second cage 550 and the membrane filter 330 and may remain there until the fluid 50 escapes through the membrane filter 330. The fluid 50 including PFAS that has been introduced into the space 340 may be filtered through the membrane filter 330 and escape through the outlet 400. In some embodiments, the space 340 is configured to hold the fluid 50 in an amount determined by a volume of the space 340 based on the predetermined distance between the second cage 550 and the membrane filter 330. When the fluid 50 including PFAS is filtered by the membrane filter 330, some of the PFAS material may be filtered by the membrane filter 330. At this time, a fluid 50 that has passed through the membrane filter 330, i.e., the fluid 55 that has passed through the PFAS capturing filter 300, may include a less amount of PFAS material than before passing through the membrane filter 330. The fluid 55 that has passed through the PFAS capturing filter 300 may be discharged out of the PFAS capturing apparatus 10 through the outlet 400. In some embodiments, the fluid 55 that has passed through the PFAS capturing filter 300 may be stored in a container 700 by free falling. The fluid 55 that has passed through the PFAS capturing filter 300 and included in the container 700 may be fed back into the PFAS capturing apparatus 10 until the number of filtrations reaches a target value, as described below.

The thermoelectric element 350 may be positioned to surround the second cage 550. According to some embodiments, the thermoelectric element 350 may be understood as a device that generates electricity using a temperature difference or may control temperature using an electric current. The thermoelectric element 350 may operate using the Peltier effect and the Seebeck effect.

The thermoelectric element 350 may be configured to control a temperature of the membrane filter 330. According to some embodiments, the thermoelectric element 350 may be configured to increase the temperature of the membrane filter 330 to a first temperature. In addition, the thermoelectric element 350 may be configured to decrease the temperature of the membrane filter 330 to a second temperature.

The thermoelectric element 350 may be configured to bend at a constant curvature. The thermoelectric element 350 may include a substrate 351, a lower copper layer 353, an N-type thermoelectric material 357, a P-type thermoelectric material 355, a solder 352, an upper copper layer 359, and a polymer layer 356.

The substrate 351 is a support layer positioned at a lower side of the thermoelectric element 350, which enables bending of the thermoelectric element, and may protect the thermoelectric element 350 from external impact. The lower copper layer 353 is a copper layer formed at an upper side of the substrate 351, which may assist in electrical connection and heat transfer of the thermoelectric element 350. The N-type thermoelectric material 357 and the P-type thermoelectric material 355 may be positioned between the lower copper layer 353 and the upper copper layer 359. The polymer layer 356 may cover side surfaces of the N-type thermoelectric material 357 and the P-type thermoelectric material 355. The polymer layer 356 may provide flexibility to the thermoelectric element 350 and enhance structural stability. In addition, the polymer layer 356 may serve as an insulating layer. The solder 352 may be positioned between the lower copper layer 353 and the N-type thermoelectric material 357, between the lower copper layer 353 and the P-type thermoelectric material 355, between the N-type thermoelectric material 357 and the upper copper layer 359, and between the P-type thermoelectric material 355 and the upper copper layer 359.

According to some embodiments, the thermoelectric element 350 may be coupled with or separated from the second cage 550. Because the thermoelectric element 350 has flexibility, the thermoelectric element 350 may tightly surround the second cage 550.

According to some embodiments, the thermoelectric element 350 may be powered by solar energy. At this time, the lower case 120 of the PFAS capturing apparatus 10 may include a transparent material. As the lower case 120 includes a transparent material, the thermoelectric element 350 may be charged by solar energy. In some embodiments, the thermoelectric element 350 may be supplied with power through a charger. In some embodiments, the thermoelectric element 350 may be powered by a battery.

When the thermoelectric element 350 raises the temperature of the membrane filter 330 to the first temperature, a surface of the membrane filter 330 may be high-temperature treated. When the surface of the membrane filter 330 is high-temperature treated, the molecular kinetic energy may be maximized, thereby improving the capture efficiency of PFAS. In some embodiments, the first temperature may have a range of about 90 °C to about 110 °C. “About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

According to some embodiments, the thermoelectric element 350 may raise the temperature of the membrane filter 330 to the first temperature before the fluid 50 including PFAS is introduced into the PFAS capturing apparatus 10.

The operation (S130) of determining whether the number of filtration cycles satisfies a target value may be determined by determining whether the fluid 50 including PFAS has passed through the PFAS capturing filter 300 the number of times set by the user. For example, if the user sets the number to 20, and the fluid 50 including PFAS passes through the PFAS capturing filter 300 less than 20 times, the fluid 55 that has passed through the PFAS capturing filter 300 and has been discharged through the outlet 400 of the PFAS capturing apparatus 10 may be provided again to the inlet 200 of the PFAS capturing apparatus 10. At least a portion of the PFAS material may be filtered in the membrane filter 330 whenever the fluid 50 including PFAS passes through the PFAS capturing apparatus 10. As a result, as the number of times the fluid 50 including PFAS passes through the PFAS capturing filter 300 increases, the amount of PFAS material remaining in the membrane filter 330 may increase. Through this operation, the concentration of PFAS remaining in the membrane filter 330 may gradually increase. The number of times set by the user may vary depending on the type of fluid 50 including PFAS, the PFAS concentration, etc. For example, if the fluid 50 including PFAS includes a lot of noise, i.e., other substances in addition to PFAS substances, the number of times set by the user may increase. In addition, the lower the PFAS concentration of the fluid 50 including PFAS, the more the number of times set by the user may increase.

When the fluid 50 including PFAS is filtered by passing through the PFAS capturing apparatus 10 as the number of times set by the user, an operation (S140) of separating the filter from the PFAS capturing apparatus 10 is performed.

The PFAS capturing filter 300 may be separated from the PFAS capturing apparatus 10. First, the upper case 110 and the lower case 120 may be separated by removing the coupling member 150, and the PFAS capturing filter 300 in the lower case 120 may be separated from the lower case 120. Thereafter, the thermoelectric element 350 and the second cage 550 may be separated from the PFAS capturing filter 300, and the membrane filter 330 may be separated from the first cage 320.

In some embodiments, before performing the operation (S140) of separating the PFAS capturing filter 300 from the PFAS capturing apparatus 10, an operation of lowering the temperature of the membrane filter 330 through the thermoelectric element 350 may be performed. In some embodiments, the operation of lowering the temperature of the membrane filter 330 through the thermoelectric element 350 may be performed for one hour.

Thereafter, an operation (S150) of immersing the filter in a solvent to separate PFAS from the filter is performed. The membrane filter 330 separated from the PFAS capturing filter 300 may be immersed in a solvent. The solvent may dissolve the PFAS material remaining in the membrane filter 330 and extract the PFAS material from the membrane filter 330. In some embodiments, the solvent may be composed of 70 wt % of methanol and 30 wt % of acetone.

In some embodiments, the method (S100) of capturing PFAS may further include an operation (S160) of analyzing the components of PFAS after the operation (S150) of immersing the membrane filter 330 in a solvent to separate PFAS from the membrane filter 330. In some embodiments, the operation of analyzing the components of PFAS may be performed through Liquid Chromatography-Mass Spectrometry (LC-MS). The LC-MS is an analytical technique that combines liquid chromatography (LC) and mass spectrometry (MS), and may be a technique used to separate, detect, identify, and quantify individual compounds in a complex mixture.

In some embodiments, the PFAS capturing apparatus 10 may further include a support 500, a handle 600, and a container 700. The support 500 may be coupled to a lower portion of the lower case 120. The support 500 may provide a space in which the container 700 may include the fluid 55 that has passed through the PFAS capturing filter 300 from the outlet 400. The handle 600 may be provided and coupled to at least one of the upper case 110 and the lower case 120. In some embodiments, the handle 600 may be combined with at least one of the upper case 110 and the lower case 120. The user may freely hold and move the PFAS capturing apparatus 10 through the handle 600. Through this, the PFAS capturing apparatus 10 may be portable.

The method (S100) of capturing PFAS and the PFAS capturing apparatus 10 according to the technical idea of the inventive concept may increase the concentration of PFAS substances remaining in the PFAS capturing filter 300 by filtering the fluid 50 including PFAS multiple times through the PFAS capturing filter 300 including the thermoelectric element 350, even when the concentration of PFAS in the fluid 50 including PFAS is low and difficult to detect from a sensor. In particular, a surface temperature of the membrane filter 330 may be increased through the thermoelectric element 350 to improve the filtration effect of the membrane filter 330. In addition, the concentration of PFAS substances remaining in the membrane filter 330 may be improved by repeatedly filtering the fluid 55 that has passed through the PFAS capturing filter 300 through the PFAS capturing filter 300. Through this way, the PFAS substances included in the fluid 50 including PFAS, which previously had a low PFAS concentration and could not be detected by the sensor, may be detected. Furthermore, the method (S100) of capturing PFAS and the PFAS capturing apparatus 10 according to the technical idea of the inventive concept detect PFAS by concentrating PFAS included in the fluid 50 including PFAS having a low concentration to a detectable concentration, and thus, the existing sensing method may be used as is.

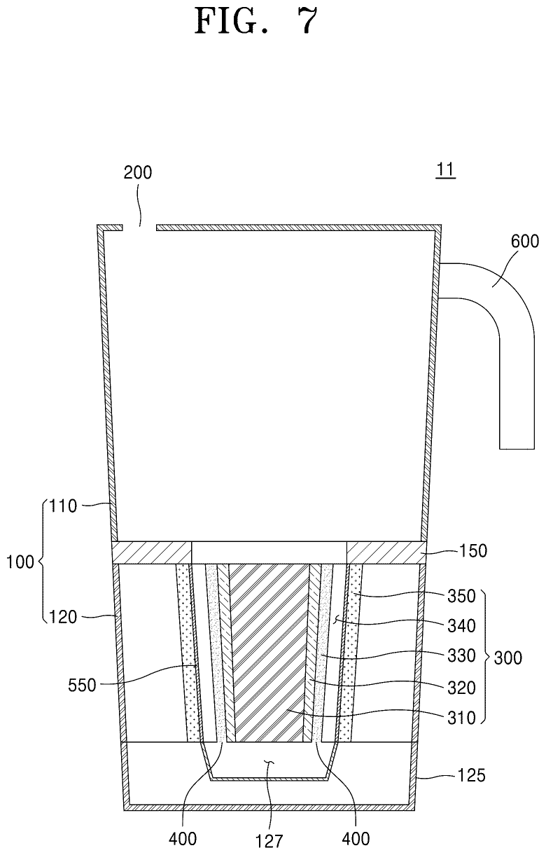

FIG. 7 is a cross-sectional view schematically showing a PFAS capturing apparatus 11 according to an embodiment. Hereinafter, the overlapping contents described with reference to FIGS. 1 to 6 are omitted, and the differences will be mainly described.

Referring to FIG. 7, the PFAS capturing apparatus 10 may include a case 100, a coupling member 150, an inlet 200, a guide unit 250, a PFAS capturing filter 300, an outlet 400, and a lower support 125. According to some embodiments, the case 100 may be configured of an upper case 110 and a lower case 120. The upper case 110 and the lower case 120 may be coupled with or separated from each other by the coupling member 150.

According to some embodiments, the upper case 110 may include an inlet 200. The inlet 200 may be located on an upper surface of the upper case 110. A fluid 50 (see FIG. 4) including PFAS may be introduced into the PFAS capturing apparatus 11 through the inlet 200.

The PFAS capturing filter 300 may be positioned within the lower case 120. The PFAS capturing filter 300 may include a first body 310, a first cage 320, a membrane filter 330, a second cage 550, and a thermoelectric element 350. The first body 310 may be positioned at the center of the PFAS capturing filter 300. According to some embodiments, the first body 310 may have a shape extending in a vertical direction (Z).

The first cage 320 may surround a side of the first body 310. The first cage 320 may be attached to the first body 310. The first cage 320 may be configured to be coupled with or separated from the first body 310. The first cage 320 may be configured to bend at a constant curvature. Accordingly, the first cage 320 may be coupled or separated while surrounding around the side of the first body 310.

According to some embodiments, the first cage 320 may include a substrate. The membrane filter 330 may be coupled with or separated from the first cage 320. The membrane filter 330 may be attached to a side of the first cage 320. The membrane filter 330 may be configured to bend at a constant curvature. Accordingly, the membrane filter 330 may be coupled or separated while surrounding around the side of the first cage 320. The second cage 550 may be provided at a predetermined distance apart from the membrane filter 330 in the horizontal direction. The second cage 550 may be configured to bend at a constant curvature. As the second cage 550 is provided at a predetermined distance from the membrane filter 330, the fluid 50 including PFAS may be provided in a space 340 between the second cage 550 and the membrane filter 330. The thermoelectric element 350 may be positioned to surround the second cage 550. The thermoelectric element 350 may be configured to control a temperature of the membrane filter 330. According to some embodiments, the thermoelectric element 350 may be configured to increase the temperature of the membrane filter 330 to a first temperature. In addition, the thermoelectric element 350 may be configured to decrease the temperature of the membrane filter 330 to a second temperature.

According to some embodiments, the coupling member 150 may cover an upper surface of the thermoelectric element 350 without gaps. An inner surface of the thermoelectric element 350 may be covered without gaps by the second cage 550, and an upper surface of the thermoelectric element 350 may be covered without gaps by the coupling member 150. Through this way, the fluid 50 including PFAS may not come into contact with the thermoelectric element 350.

According to some embodiments, the lower support 125 that may be coupled with or separated from the lower case 120 may be positioned at the lowermost end of the lower case 120. At this time, at least a portion of a lower surface of the lower case 120 may be opened. At least a portion of the lower surface of the lower case 120 may be opened so that the fluid 55 that has passed through the PFAS capturing filter 300 may be provided to the lower support 125. The lower support 125 may be combined with or separated from the lower case 120 and may include a recess 127. The fluid 50 including PFAS passes through the PFAS capturing filter 300 and is discharged through the outlet 400. At this time, the fluid 55 (see FIG. 4) that has passed through the PFAS capturing filter 300 may be introduced into the recess 127 of the lower support 125. The fluid 55 that has passed through the PFAS capturing filter 300 and stored in the recess 127 may be introduced back into the PFAS capturing apparatus 11 or provided to a PFAS analyzer.

The PFAS capturing apparatus 11 according to the technical idea of the inventive concept may store the fluid 55 that has passed through the PFAS capturing filter 300 through the recess 127 of the lower support 125 that is coupled with the lower case 120. Accordingly, the separate container 700 (see FIG. 2) is unnecessary, and the fluid 55 that has passed through the PFAS capturing filter 300 may be prevented from being discarded due to the user's carelessness in not placing the container 700 in a correct position. In addition, because the inlet 200 is located on an upper surface of the upper case 110, the fluid 50 including PFAS may be more easily introduced into the PFAS capturing apparatus 11.

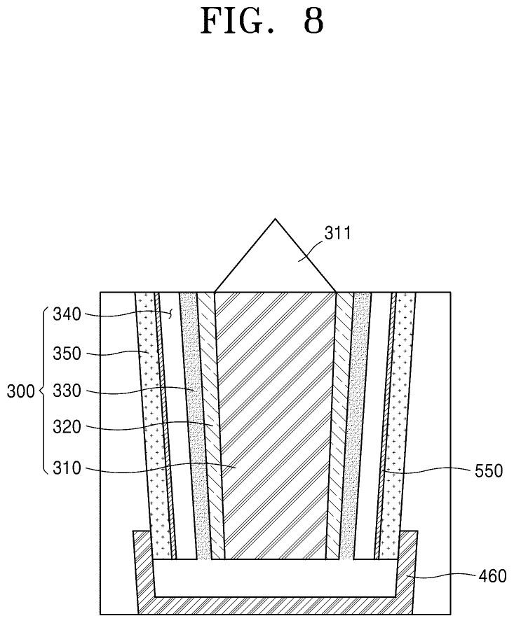

FIG. 8 is a cross-sectional view schematically showing a PFAS capturing filter according to an embodiment. Hereinafter, overlapping content described with reference to FIGS. 1 to 7 will be omitted, and differences will be mainly described.

Referring to FIG. 8, a PFAS capturing filter 301 may include a first body 310, a first cage 320, a membrane filter 330, a second cage 550, and a thermoelectric element 350. The first body 310 may be located at the center of the PFAS capturing filter 301. According to some embodiments, the first body 310 may have a shape extending in the vertical direction (Z). According to some embodiments, the first body 310 may include a protrusion 311 having a conical shape. A fluid 50 (see FIG. 4) including PFAS introduced to the PFAS capturing filter 301 through the protrusion 311 may be guided into a space 340 between the second cage 550 and the membrane filter 330.

The first cage 320 may surround a side of the first body 310. The first cage 320 may be attached to the first body 310. The first cage 320 may be configured to be coupled with or separated from the first body 310. The first cage 320 may be configured to bend at a constant curvature. Accordingly, the first cage 320 may be coupled or separated while surrounding around the side of the first body 310.

According to some embodiments, the first cage 320 may include a substrate. The membrane filter 330 may be coupled with or separated from the first cage 320. The membrane filter 330 may be attached to a side of the first cage 320. The membrane filter 330 may be configured to be bent at a predetermined curvature. Accordingly, the membrane filter 330 may be coupled or separated while surrounding around the side of the first cage 320. The second cage 550 may be provided at a predetermined distance from the membrane filter 330 in the horizontal direction. The second cage 550 may be configured to be bent at a predetermined curvature. As the second cage 550 is provided at a predetermined distance from the membrane filter 330, a fluid 50 including PFAS may be introduced into the space 340 between the second cage 550 and the membrane filter 330. The thermoelectric element 350 may be positioned to surround the second cage 550. The thermoelectric element 350 may be configured to control the temperature of the membrane filter 330. According to some embodiments, the thermoelectric element 350 may be configured to increase the temperature of the membrane filter 330 to a first temperature. In addition, the thermoelectric element 350 may be configured to decrease the temperature of the membrane filter 330 to a second temperature. In addition, a coupling container 460 may be positioned at the bottom of the PFAS capturing filter 301. The coupling container 460 may be positioned within the lower case 120 (see FIG. 2). The coupling container 460 may be combined with or separated from the lower case 120. The coupling container 460 may be configured to store the fluid 55 that has passed through the PFAS capturing filter 301.

As described above, example embodiments of the inventive concept have been disclosed in the drawings and specification. In the present specification, the example embodiments are described by using some specific terms, but the terms used are for the purpose of describing the technical scope of the inventive concept only and are not intended to be limiting of meanings or the technical scope described in the claims. Therefore, it will be understood by those skilled in the art that various changes in form and details may be made therein without departing from the spirit and scope of the inventive concept as defined by the appended claims. Accordingly, the scope of the invention is defined not by the detailed description of the invention but by the appended claims.

While the inventive concept has been particularly shown and described with reference to embodiments thereof, it will be understood that various changes in form and details may be made therein without departing from the spirit and scope of the following claims.

What is claimed is:

1. A per- and polyfluoroalkyl substances (PFAS) capturing filter comprising:
a first body extending in a vertical direction;
a first cage surrounding a side of the first body;
a membrane filter surrounding the first cage and configured to adsorb PFAS;
a second cage horizontally spaced apart from the membrane filter by a predetermined distance, surrounding the membrane filter in a lateral direction, and including a bent protrusion bent on a lower side; and
a thermoelectric element surrounding the second cage and configured to control a temperature of the membrane filter.

2. The PFAS capturing filter of claim 1, wherein the thermoelectric element is flexible and configured to be bent at a constant curvature corresponding to a structure of the second cage.

3. The PFAS capturing filter of claim 1, wherein
the thermoelectric element is configured to increase a temperature of the membrane filter to a first temperature, and
the first temperature being in a range of about 90 °C to about 110 °C.

4. The PFAS capturing filter of claim 1, wherein the thermoelectric element is powered by solar energy.

5. The PFAS capturing filter of claim 1, wherein the thermoelectric element is powered by a battery.

6. The PFAS capturing filter of claim 1, wherein the first body includes a protrusion having a conical shape is positioned on an upper surface of the first body.

7. The PFAS capturing filter of claim 1, wherein
the membrane filter includes a surface to which a self-assembled monolayer (SAM) for selective adsorption of PFAS is applied and a specific recognition site formed using molecularly imprinted polymer (MIP) technology.

8. The PFAS capturing filter of claim 1, wherein the first cage, the membrane filter, the second cage, and the thermoelectric element are each coupled with and separated from each other.

9. The PFAS capturing filter of claim 1, further comprising a space disposed between the membrane filter and the second case, wherein the space is configured to hold a fluid including the PFAS.

10. A per- and polyfluoroalkyl substance (PFAS) capturing apparatus comprising:
an upper case;
an inlet disposed on the upper case;
a lower case positioned at a lower side of the upper case and having an outlet positioned on a lower surface of the lower case;
a coupling member configured to couple the upper case and the lower case; and
a PFAS capturing filter positioned within the lower case,
wherein the PFAS capturing filter comprises:
a first body extending in a vertical direction;
a first cage surrounding a side surface of the first body;
a membrane filter surrounding the first cage and configured to adsorb PFAS;
a second cage horizontally spaced apart from the membrane filter by a predetermined distance, surrounding the membrane filter in a lateral direction, and including a bent protrusion bent at a lower side; and
a thermoelectric element surrounding the second cage and configured to control a temperature of the membrane filter.

11. The PFAS capturing apparatus of claim 10, further comprising:
a handle combined with the upper case.

12. The PFAS capturing apparatus of claim 10, further comprising:
a guide unit connecting the inlet and the PFAS capturing filter.

13. The PFAS capturing apparatus of claim 10, wherein,
each of the upper case and the lower case includes a magnetic material positioned on a surface that contacts the coupling member, and
the coupling member has magnetic properties.

14. The PFAS capturing apparatus of claim 10, wherein the coupling member is disposed directly on an upper surface of the thermoelectric element.

15. The PFAS capturing apparatus of claim 10, further comprising a lower support, wherein:
at least a portion of the lower surface of the lower case is open and configured to be coupled to the lower support, , and
the lower support includes a recess.

16. The PFAS capturing apparatus of claim 10, wherein
the thermoelectric element is configured to increase a temperature of the membrane filter to a first temperature, and
the first temperature being in a range of about 90 °C to about 110 °C.

17. The PFAS capturing apparatus of claim 10, wherein the thermoelectric element is flexible and configured to be bent at a constant curvature corresponding to a structure of the second cage.

18. A per- and polyfluoroalkyl substances (PFAS) capturing apparatus comprising: an upper case having an inlet positioned on an upper surface thereof;
a lower case positioned at a lower portion of the upper case and having an outlet positioned at a lower surface of the lower case;
a coupling member configured to couple the upper case and the lower case;
a handle coupled to the upper case; and
a PFAS capturing filter positioned within the lower case,
wherein the PFAS capturing filter comprises:
a first body extending in a vertical direction;
a first cage surrounding a side surface of the first body;
a membrane filter surrounding the first cage and configured to adsorb PFAS;
a second cage horizontally spaced apart from the membrane filter by a predetermined distance, surrounding the membrane filter in a lateral direction, and including a bent protrusion bent on a lower side; and
a thermoelectric element surrounding the second cage and configured to control the temperature of the membrane filter,
wherein the membrane filter includes a surface to which a self-assembled monolayer (SAM) for selective adsorption of PFAS is applied, and a specific recognition site formed using molecularly imprinted polymer (MIP) technology,
the first cage, the membrane filter, the second cage, and the thermoelectric element are each coupled to and separated from each other, and
the thermoelectric element is flexible and configured to be bent at a constant curvature corresponding to a structure of the second cage.

19. The PFAS capturing apparatus of claim 18, wherein:
the thermoelectric element is configured to increase a temperature of the membrane filter to a first temperature, and
the first temperature being in a range of about 90 °C to about 110 °C.

20. The PFAS capturing apparatus of claim 18, wherein the thermoelectric element is powered by solar energy.
